(19) United States
(12) Patent Application Publication
(10) Pub. No.: US 2025/0123489 A1
(43) Pub. Date: Apr. 17, 2025

(54) MIXED-REALITY WAVEGUIDE COMBINER WITH GRADIENT REFRACTIVE INDEX GRATINGS

(71) Applicant: Microsoft Technology Licensing, LLC, Redmond, WA (US)

(72) Inventors: Mervi Kaarina YLÄ-JARKKO, Hame (FI); Tuomo Antero VON LERBER, Uusimaa (FI); Lasse-Petteri LEPPANEN, Uusimaa (FI); Klaus Henrik Valtteri KALIMA, Uusimaa (FI); Pasi Petteri HEINONEN, Uusimaa (FI); Heikki Juhana HYVÄRINEN, Uusimaa (FI)

(21) Appl. No.: 18/487,750

(22) Filed: Oct. 16, 2023

(51) Int. Cl. G02B 27/01; F21V 8/00; G02B 27/00; G02B 27/42

(52) U.S. Cl. CPC G02B 27/0172; G02B 6/0036; G02B 27/0081; G02B 27/4205; G02B 2027/0178

(57) ABSTRACT

Undesirable light leakage is reduced in a mixed-reality head-mounted display device using an out-coupling diffractive optical element in a waveguide combiner that is implemented using a surface relief grating (SRG) having a gradient refractive index. The SRG has gratings with modulated depth in which shallower gratings have a lower refractive index and deeper gratings have a higher refractive index. The lower efficiency of the shallower gratings reduces forward-propagating virtual image light leaking into the real-world environment of the HMD device while simultaneously enabling light to propagate to the deeper gratings to thereby improve virtual image uniformity over the entirety of eyebox of the combiner. The SRG with gradient refractive index is alternatively fabricated using an inkjet deposition process with resin inks having different refractive indexes and subsequent nanoimprint lithography grating imprinting or physical vapor deposition by which a thickness-modulated resin layer is applied to a constant-height grating structure.

### BACKGROUND

Mixed-reality computing devices, such as head-mounted display (HMD) devices may be configured to display information to a user about virtual objects and/or real objects in a field of view. For example, a device may be configured to display, using a see-through display system having a waveguide-based combiner, virtual environments with real-world objects mixed in, or real-world environments with virtual objects mixed in. Diffractive optical elements (DOEs) can be utilized with waveguides in the display system, which operate under the principle of total internal reflection to provide entrance pupil replication of virtual images from a display engine and guide the image light to the user's eyes over an enlarged eyebox. Such DOEs can be implemented as surface relief gratings (SRGs) in various blazed, slanted, binary, multilevel, and/or analog configurations in some applications.

### SUMMARY

Disclosed are a mixed-reality waveguide combiner with gradient refractive index SRG structures and associated fabrication methods for use in an optical display system of an HMD device for mixed-reality applications in which virtual images are displayed over views of the real world by an HMD device user. The gradient refractive index is utilized in an SRG of an out-coupling DOE in the waveguide combiner to provide increased resistance against parasitic diffraction away from the HMD device user towards the surrounding world-side environment. In conventional SRGs, such field extraction in the wrong direction (referred to as “forward propagation”) can be strong, causing a phenomenon known as “eye glow” which can reduce social comfort by obscuring the user's eyes in some applications or undesirably increase HMD device observability in other applications.

In an illustrative embodiment, an out-coupling DOE comprises an SRG, disposed on a see-through waveguide propagating virtual images, having asymmetric, slanted gratings that are depth modulated in the direction of total internal reflection (TIR) propagation. The SRG includes gratings located in at least two distinct spatial regions in which each region has a distinct refractive index. The first region includes gratings with shallower depth relative to gratings in the second region. The refractive index for the shallower gratings in the first region is lower relative to that for deeper gratings in the second region. This arrangement implements a refractive index gradient across the out-coupling DOE in which efficiency of the shallower gratings is purposefully controlled to reduce world-side diffraction and lessen eye glow.

The lowered refractive index for the shallow region of the SRG enables use of deeper grating with greater realized slant, compared with conventional designs, which results in improvements in uniformity for replicated virtual image pupils across the entirety of the field of view (FOV) of the HMD device. Reduced parasitic loss may also facilitate a brighter eye-side virtual image rendering which may be desirable in some applications and/or improve power utilization efficiency and battery life. In other out-coupling DOE embodiments, one or more additional spatial regions are utilized to gradually transition the refractive index between the shallower and deeper gratings in the SRG.

In an illustrative fabrication method, grayscale inkjet printing processes using UV (ultraviolet) light-curable resins with different refractive indexes, droplet sizes/volumes, and application patterns (in three-dimensional space) are employed to produce an SRG for an out-coupling DOE having a gradient refractive index. The inkjet-printed resins, subsequent to inkjet application to a see-through optical waveguide substrate, are imprinted using nanoimprint lithography (NIL) techniques, such as a jet and flash imprint lithography (J-FIL), to create asymmetric, slanted grating features with modulated grating depth. The grayscale resin layers are applied by the inkjet in a “wet mixing” process to enable precise control of uncured resin thickness and modulation of refractive index as a function of grating depth and location on the SRG while minimizing flat surfaces, referred to as a bias layer, that remain in the grating trenches after grating replication.

Subsequent resin development or processing may also be used to evacuate resin from the grating trenches to reduce Fresnel reflections that could otherwise be induced at the media interface between the bias layer and the waveguide substrate, which can negatively increase unwanted forward propagation and negatively reduce the FOV of the out-coupling DOE.

In another illustrative fabrication method, physical vapor deposition (PVD) processes such as thermal evaporation or sputtering are utilized to apply a layer of low refractive index resin having modulated thickness over an SRG with constant-height slanted gratings. The PVD processes enable precise control over the modulated layer thickness to provide an SRG with a gradient refractive index with a minimized bias layer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 is a pictorial view of an illustrative example of a mixed-reality head-mounted display (HMD) device;

FIG. 2 shows a block diagram of an illustrative example of a mixed-reality HMD device;

FIG. 3 illustratively shows virtual images that are overlayed onto real-world images within a field of view (FOV) of a mixed-reality HMD device;

FIG. 4 shows illustrative components of a display system that may be utilized in an HMD device;

FIG. 5 shows propagation of light in a waveguide by total internal reflection (TIR);

FIG. 6 shows a top view of an illustrative waveguide combiner that includes an exit pupil expander;

FIG. 7 shows a front view of an illustrative waveguide combiner with an exit pupil expander in which the exit pupil is expanded along two directions of the field of view (FOV) via pupil replication;

FIG. 8 shows an illustrative input to an exit pupil expander in which the FOV is described by angles in horizontal, vertical, or diagonal orientations;

FIG. 9 illustratively shows a field propagating in a waveguide combiner being extracted on the real-world side of the combiner that produces a phenomenon referred to as “eye glow”;

FIG. 10 shows a front view of a user with an HMD device in which eye glow causes partial occlusion of the user's eyes, among other issues;

FIG. 11 shows an illustrative arrangement of diffractive optical elements (DOEs) configured for in-coupling, exit pupil expansion in two directions, and out-coupling;

FIGS. 12A, 12B, and 12C show illustrative configurations for waveguide plates that support propagation of different wavelengths of light as components of an RGB (red, green, blue) color model;

FIG. 13 shows a profile of a portion of an illustrative binary diffraction grating having straight gratings;

FIG. 14 shows an asymmetric profile of a portion of an illustrative slanted diffraction grating having asymmetric gratings;

FIG. 15 shows illustrative DOEs with varying grating depth fabricated using resins having different refractive indexes;

FIG. 16A shows an illustrative out-coupling DOE having depth-modulated gratings disposed across three regions-a low refractive index region, a high refractive index region, and a transition region that is implemented by mixing two or more resins each having a different refractive index;

FIG. 16B shows an edge view of an illustrative out-coupling DOE having depth-modulated gratings;

FIG. 17 shows variation in refractive index over a transition region in an illustrative out-coupling DOE;

FIGS. 18, 19, and 20 show illustrative arrangements for inkjet printing equipment used in the fabrication of DOEs;

FIG. 21 shows an illustrative one-dimensional array of resin droplets disposed on a substrate, in which the resin droplets have different and/or mixed refractive indexes in various spatial patterns;

FIGS. 22A, 22B, and 22C show illustrative processes for manufacturing surface relief gratings using a nanoimprint lithography (NIL) technique;

FIG. 23 shows an illustrative SRG in an out-coupling DOE having a constant-depth structure over which a layer of low refractive index resin is deposited;

FIG. 24 is a flowchart of an illustrative method for fabricating a waveguide combiner with gradient refractive index gratings;

FIG. 25 is a flowchart of an illustrative method for fabricating a waveguide combiner with gradient refractive index gratings; and

FIG. 26 shows a block diagram of an illustrative electronic device that incorporates a mixed-reality display system using the present waveguide combiner with gradient refractive index gratings.

Like reference numerals indicate like elements in the drawings. Elements are not drawn to scale.

### DETAILED DESCRIPTION

Light for virtual images in mixed-reality applications, in which images of virtual objects are combined with views of the real world, can leak from HMD and other electronic devices that employ waveguide-based combiners having optical couplers. Such light is typically considered wasted because it is not used to display virtual images to a device user and thus an energy cost is imposed which is typically undesirable for battery-powered devices. Light leaking from the waveguide combiner that propagates in a forward direction towards the real-world side of the device (as opposed to the rearward direction towards the eye side of the device) is often manifested as “eye glow” which raises security concerns in some mixed-reality HMD device use cases in which detectability of device users is sought to be minimized, for example, in military and security environments. Such forward-propagating virtual image light, sometimes referred to as forward-projecting light, can also overlay a user's eyes when seen by an observer. This phenomenon presents social interaction difficulties between mixed-reality HMD device users by limiting eye contact in some use cases.

The present mixed-reality waveguide combiner with gradient refractive index gratings advantageously enables virtual image light, that would otherwise be forward propagated, to be effectively propagated throughout the out-coupling DOE to provide high uniformity across the replicated pupils over an enlarged eyebox. In some implementations, brightness of the virtual image display can be increased on the waveguide combiner without a concomitant increase in electrical power. In addition, reducing the forward-propagating virtual image light that leaks from the waveguide combiner lowers device and user detectability, particularly, for example, in low-light scenarios where eye glow can present a security risk. Reduction in the forward-propagating virtual image light also improves social interaction among mixed-reality device users by reducing virtual image overlay with a user's eyes to facilitate eye contact.

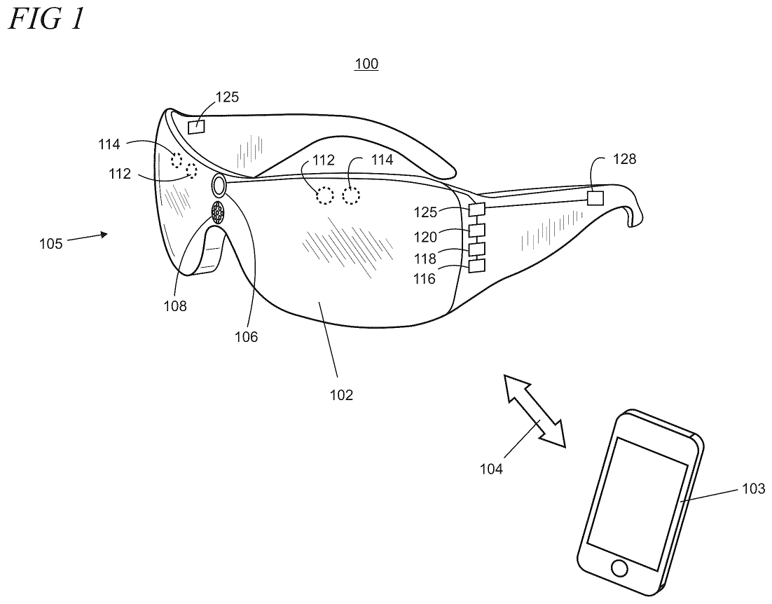

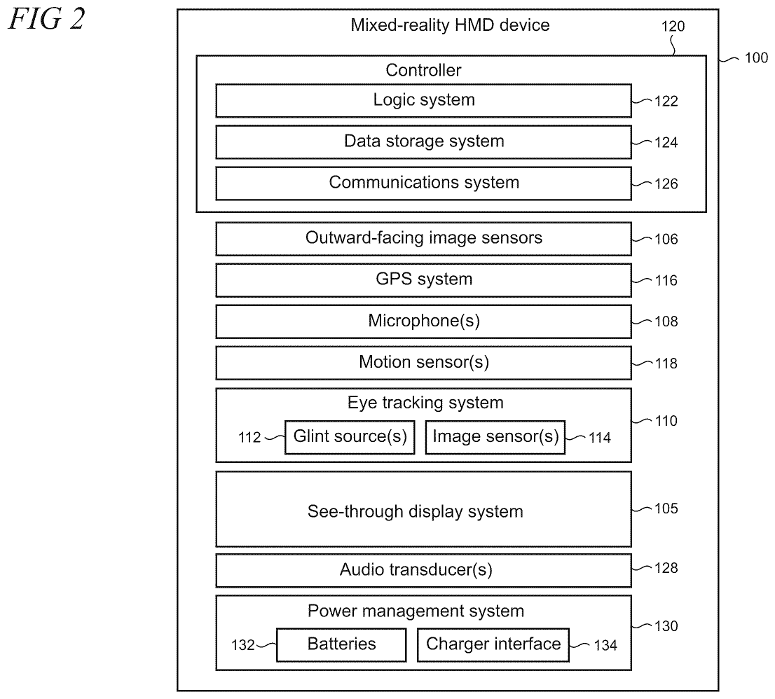

Turning now to the drawings, FIG. 1 shows an illustrative example of a mixed-reality HMD device 100 that utilizes a see-through display system 105, and FIG. 2 shows a functional block diagram of the HMD device. The HMD device comprises one or more lenses 102 that form a part of the see-through display system 105. Virtual images are displayed using the lenses which incorporate one or more waveguide-based display systems, such as a near-eye display system. The display system also includes one or more display engines 125 that are configured to produce virtual images for rendering by the system. In this particular implementation, separate display engines are utilized for each lens to support binocular/stereoscopic operations and are located in the respective temples of the HMD device. In other implementations, other suitable configurations are usable, and may include a single display engine that is shared between the lenses using, for example, switching, scanning, multiplexing, or the like. Single eye display system configurations are also supported by the present principles.

The HMD device 100, in this illustrative example, further incorporates one or more sensors, processors, memories, or systems that provide additional capabilities and functions for the device. In alternative embodiments, the sensors, processors, memories, or systems are partially or fully supported in an external computing device 103 such as a smartphone or other suitable electronic device that is operatively coupled to the HMD device over a wired or wireless communication and control interface(s) 104, or the sensors, processors, memories, or systems are distributed and/or replicated across the HMD and external computing device.

As shown in FIG. 1, outward-facing image sensors 106 are configured to acquire images of a background scene and/or a physical environment being viewed by a user and typically includes one or more microphones 108 configured to detect sounds, such as voice commands from a user. Outward-facing image sensors 106 typically include one or more depth sensors and/or one or more two-dimensional image sensors.

The HMD device 100 may further include an eye-tracking system 110 configured for detecting a direction of gaze of each eye of a user (not shown) or a direction or location of focus. The eye-tracking system can optionally include a body tracking system such as a hand tracker, or a body tracking system can be separately instantiated. The eye-tracking system is configurable to determine gaze directions of each of a user's eyes in any suitable manner. For example, in the illustrative example shown, the eye-tracking system includes one or more glint sources 112, such as infrared light sources, that are configured to cause a glint of light to reflect from each eyeball of a user, and one or more image sensors 114, such as inward-facing sensors, that are configured to capture an image of each eyeball of the user. Changes in the glints from the user's eyeballs and/or a location of a user's pupil, as determined from image data gathered using the image sensors 114, are used to determine a direction of gaze.

In addition, a location at which gaze lines projected from the user's eyes intersect the external display may be used to determine an object at which the user is gazing (e.g., a displayed virtual object and/or real background object). The eye-tracking system 110 includes any suitable number and arrangement of light sources and image sensors. In some implementations, the eye-tracking system is omitted from the HMD device.

The HMD device 100 generally includes additional sensors. For example, the HMD device comprises a global positioning system (GPS) system 116 to allow a location of the HMD device to be determined. This may help to identify real-world objects, such as buildings, etc., that are located in the user's adjoining physical environment.

The HMD device 100 typically includes one or more motion sensors 118 (e.g., inertial, multi-axis gyroscopic, or acceleration sensors) to detect movement and position/orientation/pose of a user's head when the user is wearing the system as part of a mixed-reality or virtual-reality HMD device. Motion data is usable, potentially along with eye-tracking glint data and outward-facing image data, for gaze detection and eye and/or body tracking, as well as for image stabilization to help correct for blur in images from the outward-facing image sensors 106. The use of motion data generally allows for changes in gaze direction to be tracked even if image data from outward-facing image sensors cannot be resolved.

In addition, motion sensors 118, as well as the microphones 108 and eye-tracking system 110 (and/or an optional body tracking system), also are employed as user input devices in some cases, such that a user may interact with the HMD device 100 via gestures of the eye, neck, head and/or fingers/hands, as well as via verbal commands in some cases. It may be understood that the sensors illustrated in FIGS. 1 and 2 and described in the accompanying text are included for the purpose of example and are not intended to be limiting in any manner, as any other suitable sensors and/or combination of sensors may be utilized to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) may be utilized in some implementations.

The HMD device 100 further includes a controller 120 such as one or more processors having a logic system 122 and a data storage system 124 in communication with the sensors, eye-tracking system 110, display system 105, and/or other components through a communications system 126. The communications system 126 can also facilitate the display system 105 being operated in conjunction with remotely located resources, such as processing, storage, power, data, and services. That is, in some implementations, an HMD device can be operated as part of a system that can distribute resources and capabilities among different components and systems.

The storage system 124 includes instructions stored thereon that are executable by logic system 122, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The HMD device 100 is configured with one or more audio transducers 128 (e.g., speakers, earphones, etc.) so that audio can be utilized as part of a mixed-reality or virtual-reality experience. A power management system 130 may include one or more batteries 132 and/or protection circuit modules (PCMs) and an associated charger interface 134 and/or remote power interface for supplying power to components in the HMD device 100.

It may be appreciated that the HMD device 100 is described for the purpose of example, and thus is not meant to be limiting. It may be further understood that the display device may include additional and/or alternative sensors, cameras, microphones, input devices, output devices, etc. than those shown without departing from the scope of the present arrangement. Additionally, the physical configuration of an HMD device and its various sensors and subcomponents may take a variety of different forms without departing from the scope of the present arrangement.

The display system 105 is arranged in some implementations as a near-eye display. In a near-eye display, the display engine or imaging device does not actually shine the images on a surface such as a glass lens to create the display for the user. This is not feasible because the human eye cannot focus on something that is that close. Rather than create a visible image on a surface, the near-eye display uses an optical system to form a pupil and the user's eye acts as the last element in the optical chain and converts the light from the pupil into an image on the eye's retina as a virtual display. It may be appreciated that the exit pupil is a virtual aperture in an optical system. Only rays which pass through this virtual aperture can exit the system. Thus, the exit pupil describes a minimum diameter of the virtual image light after leaving the display system. The exit pupil defines the eyebox which comprises a spatial range of eye positions of the user in which the virtual images projected by the display system are visible.

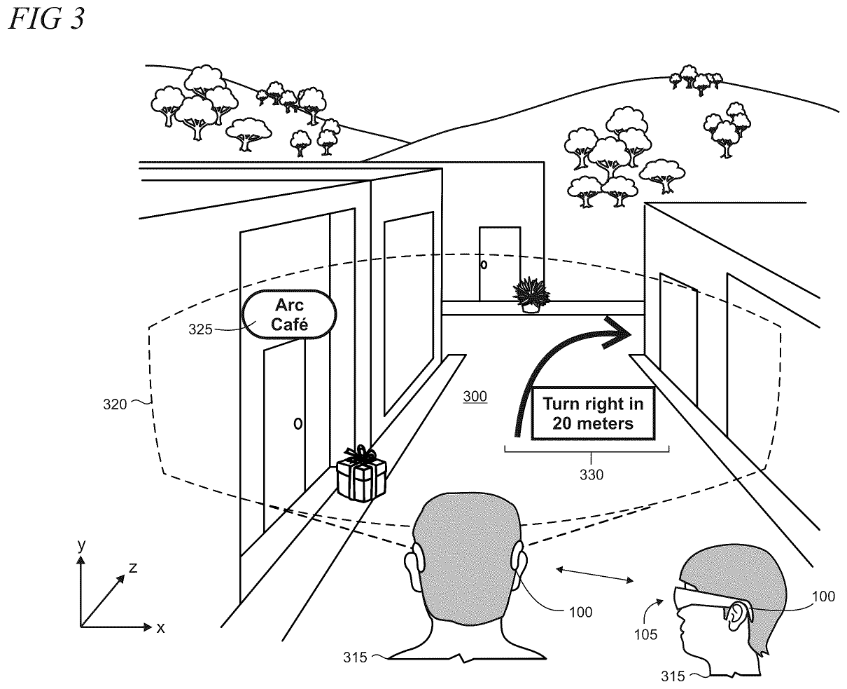

FIG. 3 shows the HMD device 100 worn by a user 315 as configured for mixed-reality experiences in which the display system 105 is implemented as a near-eye display system having at least a partially transparent, see-through waveguide combiner, among various other components. As noted above, a suitable display engine (not shown) generates virtual images that are guided by the waveguide in the display system to the user. Being see-through, the waveguide combiner in the display system enables the user to perceive light from objects and scenes in the real world.

The display system 105 can render images of various virtual objects that are superimposed over the real-world views that are collectively observed using the see-through waveguide combiner to thereby create a mixed-reality environment 300 within the HMD device's FOV (field of view) 320. It is noted that the FOV of the real world and the FOV of the images in the virtual world are not necessarily identical, as the virtual FOV provided by the display system is typically a subset of the real FOV. FOV is typically described as an angular range in horizontal, vertical, or diagonal dimensions over which virtual images can be projected.

It is noted that FOV is just one of many parameters that are typically considered and balanced by HMD device designers to meet the requirements of a particular implementation. For example, such parameters may include eyebox size, brightness, transparency and duty time, contrast, resolution, color fidelity, depth perception, size, weight, form-factor, and user comfort (i.e., wearable, visual, and social), among others.

In the illustrative example shown in FIG. 3, the user 315 is physically walking in a real-world urban area that includes city streets with various buildings, stores, etc., with a countryside in the distance. The FOV 320 of the cityscape viewed on HMD device 100 changes as the user moves through the real-world environment and the device can render static and/or dynamic virtual images over the real-world view. In this illustrative example, the virtual images include a tag 325 that identifies a restaurant business and directions 330 to a place of interest in the city. The mixed-reality environment 300 seen visually on the display system 105 may also be supplemented by audio and/or tactile/haptic sensations produced by the HMD device in some implementations.

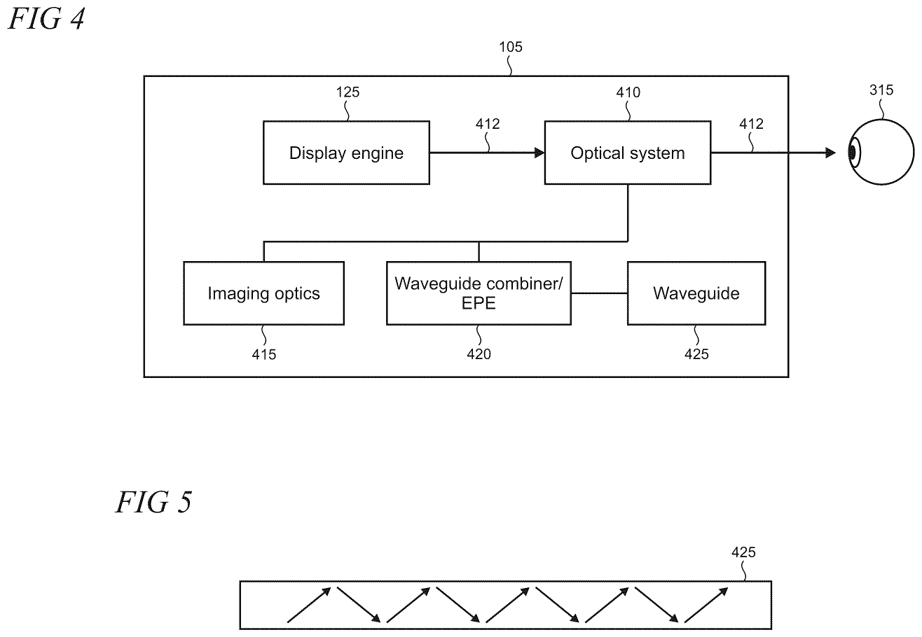

FIG. 4 shows illustrative components of the display system 105 utilized in the HMD device 100 in an illustrative mixed-reality embodiment. The display system includes a display engine 125 and an optical system 410 to provide virtual images and views of the real world to the user 315 over a light path 412. The optical system includes imaging optics 415 to support an optical interface between the light engine and a waveguide combiner 420 which, in this example, includes an exit pupil expander (EPE) functionality. The waveguide combiner 420 is typically incorporated into the lenses 102 of the HMD device (FIG. 1). The imaging optics typically include optical elements such as lenses, mirrors, filters, gratings, and the like, and may further include electromechanical elements such as MEMS devices in scanning-type display engine implementations.

A waveguide 425 facilitates light transmission between the display engine 125 and the user's eye 315 over the light path 412. One or more waveguides can be utilized in the display system 105 because they are transparent (or partially transparent in some implementations) and because they are generally small and lightweight (which is desirable for HMD devices where size and weight are generally sought to be minimized for reasons of performance and user comfort). For example, the waveguide can enable the display engine to be located out of the way, for example, on the side of the user's head or near the forehead, leaving only a relatively small, light, and transparent waveguide optical element in front of the eyes.

In an illustrative implementation, the waveguide 425 operates using a principle of total internal reflection (TIR), as shown in FIG. 5, so that light can be coupled among the various optical elements in the display system 105. TIR is a phenomenon which occurs when a propagating light wave strikes a medium boundary (e.g., as provided by the optical substrate of a waveguide) at an angle larger than the critical angle with respect to the normal to the surface. In other words, the critical angle (θ_{c}) is the angle of incidence above which TIR occurs, which is given by Snell's Law, as is known in the art. More specifically, Snell's law specifies that the critical angle (θ_{c}) is specified using the following equation:

$${θ}_{c} = {sin}^{- 1} ( n 2 / n 1 )$$

where θ_{c} is the critical angle for two optical mediums (e.g., the waveguide substrate and air or some other medium that is adjacent to the substrate) that meet at a medium boundary, n1 is the index of refraction of the optical medium in which light is traveling towards the medium boundary (e.g., the waveguide substrate, once the light is coupled therein), and n2 is the index of refraction of the optical medium beyond the medium boundary (e.g., air or some other medium adjacent to the waveguide substrate).

As discussed in more detail below, the waveguide 425 is configured to support diffractive optical elements (DOEs) using, for example, surface relief gratings (SRGs) to guide light propagation over the light path 412 in the waveguide combiner 420 within a defined spatial region within the waveguide.

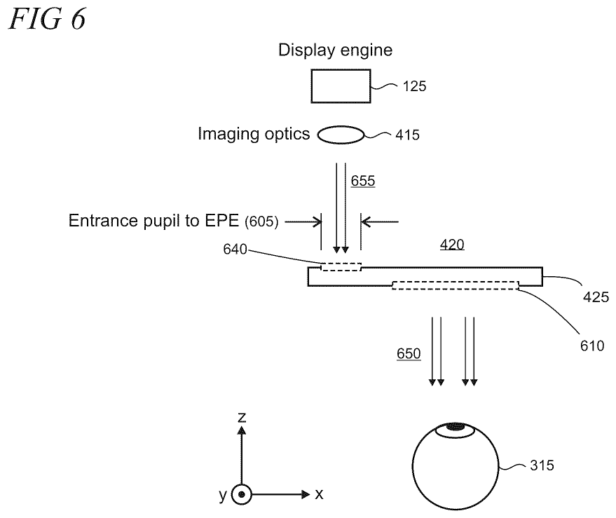

FIG. 6 shows a top view of a portion of an illustrative waveguide combiner 420, display engine 125 and imaging optics 415 to generate, for example, virtual images for the user 315. The waveguide combiner includes EPE functionality and receives one or more input optical beams from a respective display engine as an entrance pupil 605 for virtual image light to produce one or more output optical beams with expanded exit pupil in one or two directions relative to the input. The expanded exit pupil typically facilitates a virtual display to be sufficiently sized to meet the various design requirements, such as eyebox size, image resolution, FOV, and the like, of a given optical system while enabling the imager and associated components to be relatively light and compact.

FIG. 6 shows what is commonly referred to as a periscope configuration as the virtual images from the display engine are coupled into the waveguide combiner on the opposite side of the virtual image output to the user. A mirror configuration may also be utilized in other applications (for example, as with the HMD device 100 shown in FIG. 1) in which the display engine and user are located on the same side of the waveguide combiner.

The waveguide combiner 420 utilizes an output-coupling DOE 610 that is disposed on the waveguide 425 and an input-coupling DOE 640 that is disposed on the opposite side. The input- and output-coupling DOEs are configured using SRGs with modulated grating depth, as described below. One or more intermediate DOEs (not shown in FIG. 6) are disposed on waveguides which may also utilize depth-modulated gratings. The DOEs are generally arrangeable in various configurations on the waveguides, for example, on the same side or different sides of the waveguides and may further be single- or double-sided in some implementations. While the waveguide combiner is depicted as having a planar configuration, other shapes may also be utilized including, for example, curved or partially spherical shapes, in which case, grating structures in the DOEs disposed thereon may be non-co-planar.

Exemplary output beams 650 from the waveguide combiner 420 are parallel to the exemplary input beams 655 that are output from the display engine 125 to the input-coupling DOE 640. In some implementations, the input beams are collimated such that the output beams are also collimated, as indicated by the parallel lines in the drawing. Typically, in waveguide-based combiners, the input pupil needs to be formed over a collimated field, otherwise each waveguide exit pupil will produce an image at a slightly different distance. This results in a mixed visual experience in which images overlap with different focal depths in an optical phenomenon known as focus spread.

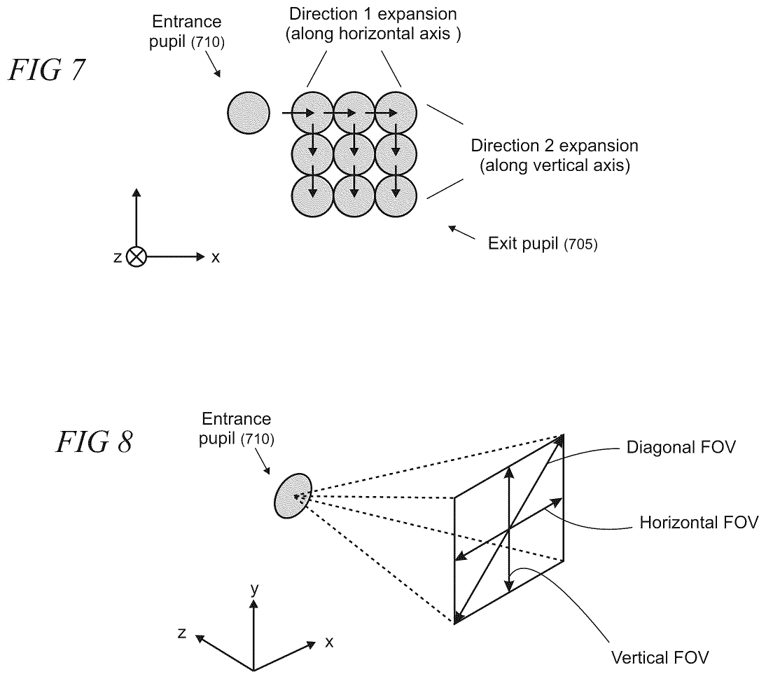

As shown in FIG. 7, the waveguide combiner is configured to provide an expanded exit pupil 705 in two directions (i.e., along each of a first and second coordinate axis) compared with the entrance pupil 710 at the input coupler (not shown) of the waveguide combiner. The exit pupil is expanded in both the vertical and horizontal directions. It may be understood that the terms “left,” “right,” “up,” “down,” “direction,” “horizontal,” and “vertical” are used primarily to establish relative orientations in the illustrative examples shown and described herein for ease of description. These terms may be intuitive for a usage scenario in which the user of the near-eye display system is upright and forward facing, but less intuitive for other usage scenarios. The listed terms are not to be construed to limit the scope of the configurations (and usage scenarios therein) of near-eye display features utilized in the present arrangement. The entrance pupil 710 to the waveguide combiner at an input coupler is generally described in terms of FOV, for example, using horizontal FOV, vertical FOV, or diagonal FOV as shown in FIG. 8.

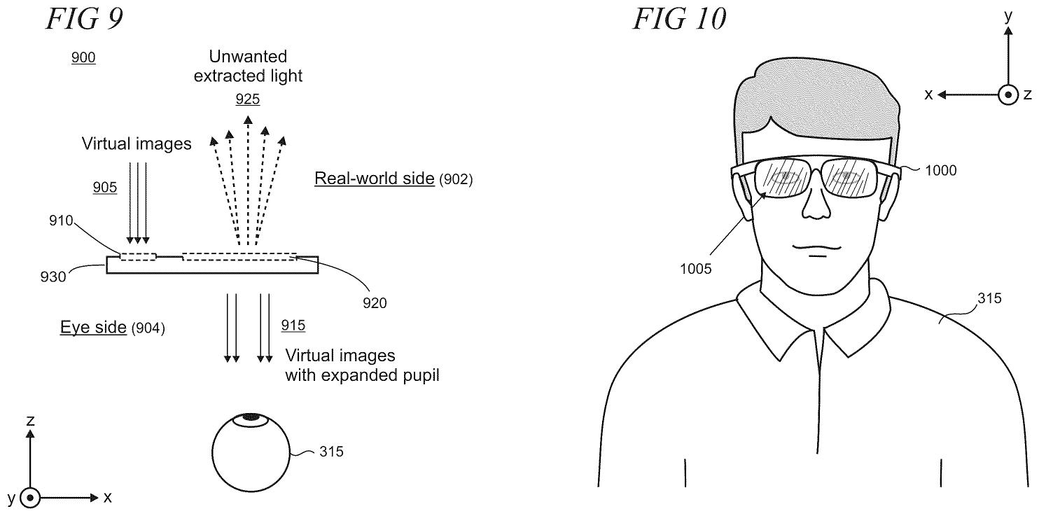

While conventional SRGs can provide satisfactory performance in many applications, they are prone to a phenomenon referred to here as “eye glow.” As shown in FIG. 9, virtual images 905 in-coupled from a display engine (not shown) at an in-coupling DOE 910 are out-coupled as beams 915 to the user 315 via a conventionally-configured out-coupling DOE 920 towards the eye side 904 of the display system 900. Simultaneously, some virtual image fields 925 are extracted from the waveguide 930 randomly towards the real-world side 902 of a display system. In typical multicolor HMD device configurations using conventional SRGs, the eye glow can be especially strong in a rainbow of colors. While the extracted field is undesired because it lowers the efficiency of the display system and wastes light, it can also present some issues during HMD device use, as discussed below.

FIG. 10 shows a user 315 wearing an HMD device 1000 that uses conventional SRGs in its display system. As indicated by reference numeral 1005, eye glow directed towards the real-world side of the device manifested by the unwanted extracted field can partially or completely obscure the eyes of the user. In some mixed-reality environments, for example, a “hybrid presence” is experienced in which the user has a sense of presence of both virtual and real human beings. If eyes are replaced by eye glow, then eye contact among device users can be difficult to maintain. This can diminish the experience of a real presence and thereby reduce social comfort of the HMD device user.

In other HMD device use scenarios, the visibility of the forward projecting eye glow to others can negatively impact a user's experience, for example, at nighttime or in dark environments. Readily perceived eye glow may represent a security risk when an HMD device user's location should not be revealed, for example in security/police/military settings.

FIG. 11 is a pictorial view of an illustrative arrangement of DOEs in one of the waveguide combiners in a lens implementing a see-through waveguide 1105 of the display system 105 in an HMD device. The DOEs are configured for in-coupling, exit pupil expansion in two directions, and out-coupling via virtual image light propagation paths, as shown. The in-coupling DOE 1110 receives virtual images from a display engine (not shown) and couples them to the intermediate DOE 1115 which expands the exit pupil in a first direction and couples the virtual image light to the out-coupling DOE 1120. The out-coupling DOE expands the exit pupil in a second direction (that is orthogonal to the first direction) and out-couples the virtual image light to a user's eye (not shown) with an exit pupil that is expanded in two directions compared to an entrance pupil at the in-coupling DOE.

The present waveguide combiner with gradient refractive index gratings is configurable to support monochromatic or polychromatic rendering of virtual images in the display system 105 of the HMD device 100 (FIG. 1). For monochromatic applications, a single-layer waveguide combiner is generally utilized to render monochromatic virtual images over views of the real world. For polychromatic applications, the waveguide combiner is typically implemented using multiple waveguide plates and associated DOEs in a stacked arrangement.

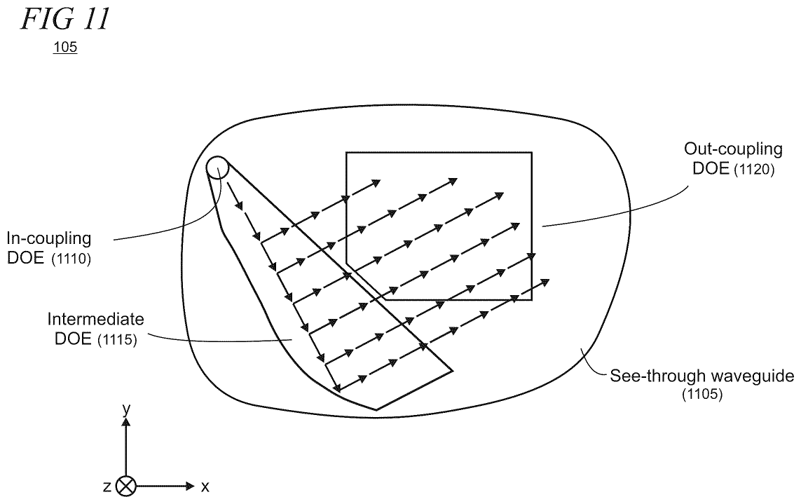

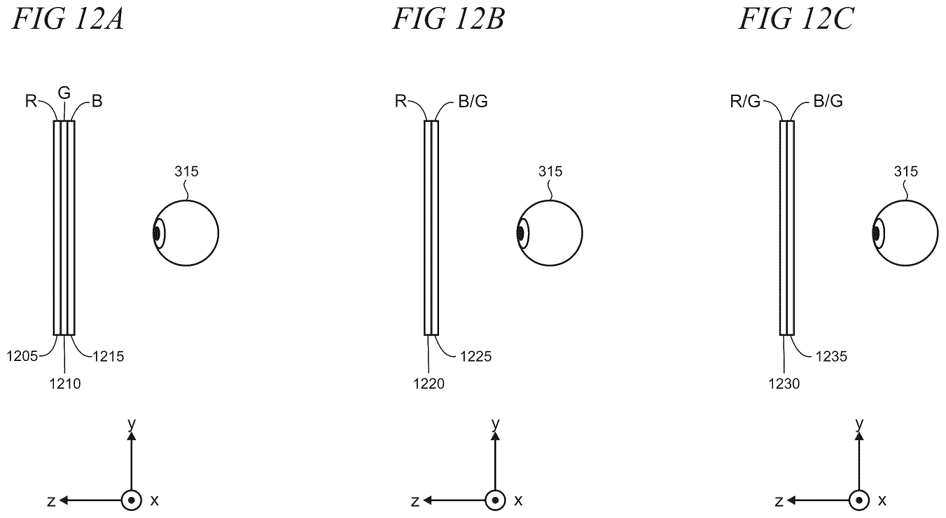

FIG. 12A shows a stack of three waveguide plates (the DOEs are not shown for clarity in exposition), indicated by reference numerals 1205, 1210, and 1215, in which each plate handles a separate color of an RGB (red, green, blue) color space. While RGB is commonly utilized, other suitable color spaces are usable to meet the requirements of a given application. It is noted that the order of the RGB plates is arbitrary in the drawing, and variations from what is shown may be utilized.

Two waveguide plates are alternatively utilizable to support the RGB color space. As shown in FIG. 12B, a plate 1220 supports the red component while a second plate 1225 in the stack supports both the green and blue components of the RGB color space. As shown in FIG. 12C, a plate 1230 supports the red component of the RGB color space over the entirety of the FOV of the display and also supports a selected portion of the FOV of the green component. Plate 1235 supports the blue component over the entirety of the FOV and the remaining FOV of the green component of the RGB color space. Other suitable variations in plate configuration and color space splits may also be utilized to meet particular requirements while still benefiting from the present principles.

The design of current SRGs typically implements control of light diffraction and propagation by the configuration of grating structures on a nanometer scale. Grating period, orientation, slant angle, and grating depth are exemplary parameters that are selected and balanced to achieve performance of a DOE that meets design requirements. For example, in current SRG designs, the depth of gratings that are closest to the light input of a DOE are typically shallow to enable suitable light propagation through the DOE to fill in all angles of the FOV with satisfactory color balance and display uniformity and brightness with fewest artifacts. However, when gratings have a shallow design, when fabricated during manufacturing, the structures are realized as binary gratings in actual practice because there is generally insufficient dimensional freedom to realize effective slanted gratings.

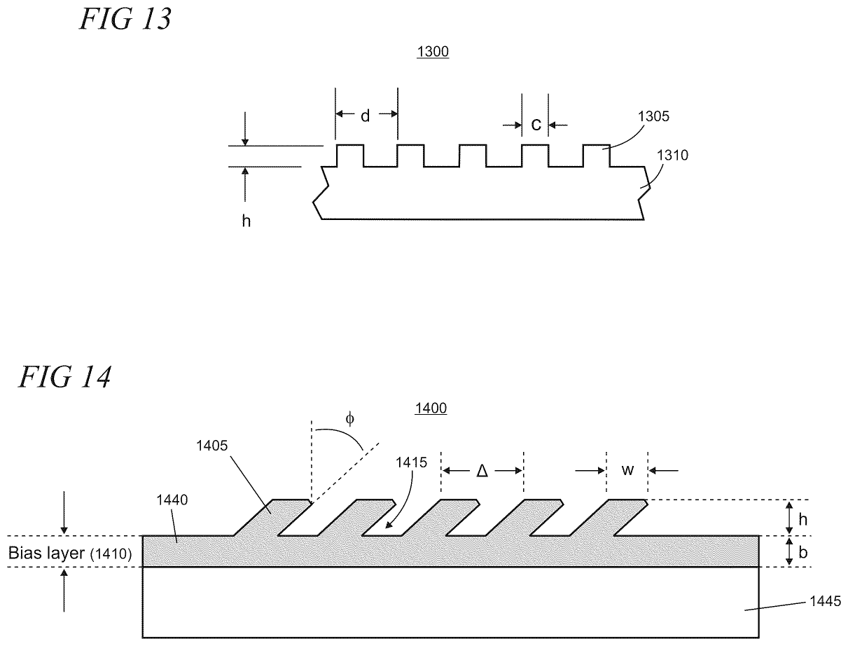

FIG. 13 shows a profile of a portion of a binary SRG 1300 in an out-coupling DOE having straight (i.e., non-slanted) grating features (representatively indicated by reference numeral 1305 and commonly referred to as grating bars, grating lines, or simply “gratings”), that are formed in a substrate 1310. The grating period is represented by d, the grating height by h (also referred to as grating “depth”), bar width by c, and the fill factor by f, where f=c/d. A limitation of binary gratings is that light is almost equally diffracted to the eye-side and the unwanted real-world side of the out-coupling DOE as forward-propagating parasitic losses.

By comparison to the binary grating features of the SRG 1300 in FIG. 13, FIG. 14 shows a profile of a portion of SRG 1400 with slanted grating features that is usable in an out-coupling DOE. As shown, the grating features (representatively indicated by reference numeral 1405) are slanted at some predetermined angle ¢ with a groove period of A. Slanted gratings can be very versatile elements and generally provide SRG design flexibility because their spectral and angular bandwidths can be tuned by the slant angles. Front and back slant angles in a same period (or from period to period) can be carefully tuned to achieve the desired angular and spectral operation. The width of the gratings is w and the height of the gratings 1405 is h.

The SRG 1400 includes a bias layer 1410 with height b that results from an incomplete evacuation of resin from the trenches 1415 between the grating features during fabrication. The bias layer operates as a flat interface which may act as a Fresnel reflection surface that can limit the FOV of the fields that propagate from the waveguide substrate to the gratings. Unwanted Fresnel reflections generally increase as the difference in refractive indexes of the resin 1440 and underlying optical substrate of the waveguide 1445 increases.

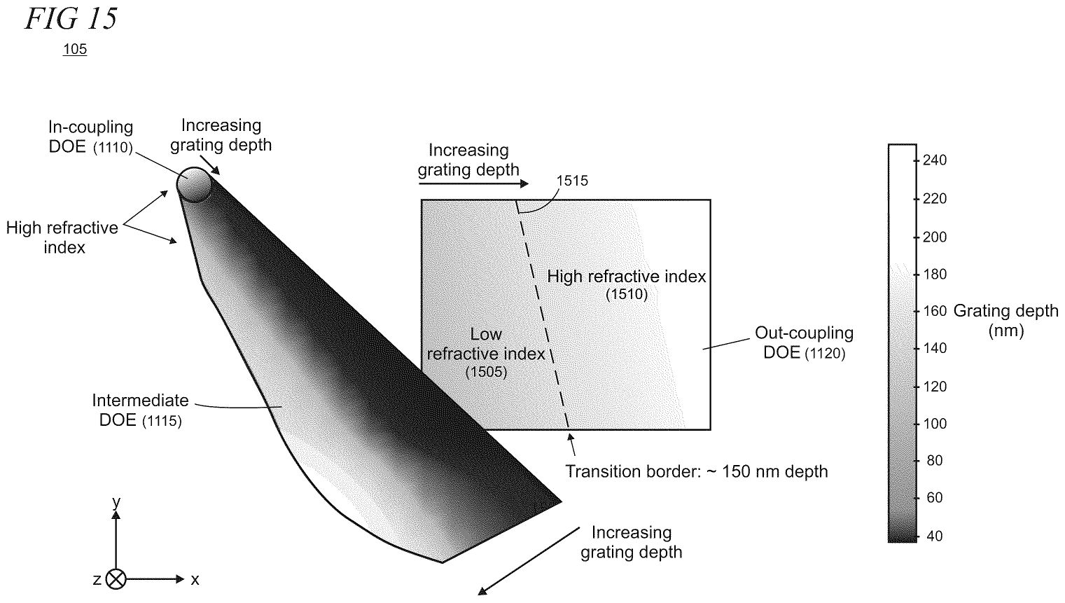

The foregoing limitations arising from shallow gratings with respect to binary realization discussed above are addressed by an out-coupling DOE having depth-modulated gratings that implement a gradient refractive index. In the illustrative example shown in FIG. 15, each of the in-coupling, intermediate, and out-coupling DOEs 1110, 1115, and 1120 in the display system 105 have depth-modulated gratings that vary in depth along the directions shown by the arrows and indicated by the shading (where darker shaded gratings are shallower relative to lighter shaded gratings). For example in this particular implementation, but not by way of limitation, the grating depth varies from approximately 100 nm to 250 nm.

The DOEs in the display system 105 are fabricated using optical materials having two different refractive indexes-one lower relative to the other. For example, and not by way of limitation, the low refractive index is approximately 1.6 and the high refractive index is approximately 1.85. It is emphasized that the use of materials with two different refractive indexes is illustrative and should not be construed as a limitation on the scope of the present invention. In some applications, more than two materials, each with a different refractive index, are used as may be required to meet target design parameters.

In this illustrative example, as shown in FIG. 15, the SRGs in the in-coupling DOE 1110 and intermediate DOE 1115 are fabricated with the high refractive index material. The SRG in the out-coupling DOE 1120 is fabricated with a combination of low and high refractive index material. The low refractive index material 1505 is used for the shallower gratings on the left side of the out-coupling DOE, closest to the intermediate DOE. The high refractive index material 1510 is used for the deeper gratings on the right side of the out-coupling DOE farthest from the intermediate DOE. The transition border between the low and high refractive index materials used in the SRG in the out-coupling DOE is located at approximately 150 nm grating depth, as indicated by the dashed line 1515.

The use of low refractive index material for the shallower gratings in the out-coupling DOE 1120 purposely lowers the efficiency of the SRG in diffracting light in both the eye-side and real-world-side directions which advantageously reduces parasitic eye glow. In addition, the tradeoff in lowered efficiency of shallower gratings with low refractive index is that more light is available to be propagated along the TIR path in the out-coupling DOE which improves uniformity across the replicated exit pupils in the enlarged eyebox of the out-coupling DOE.

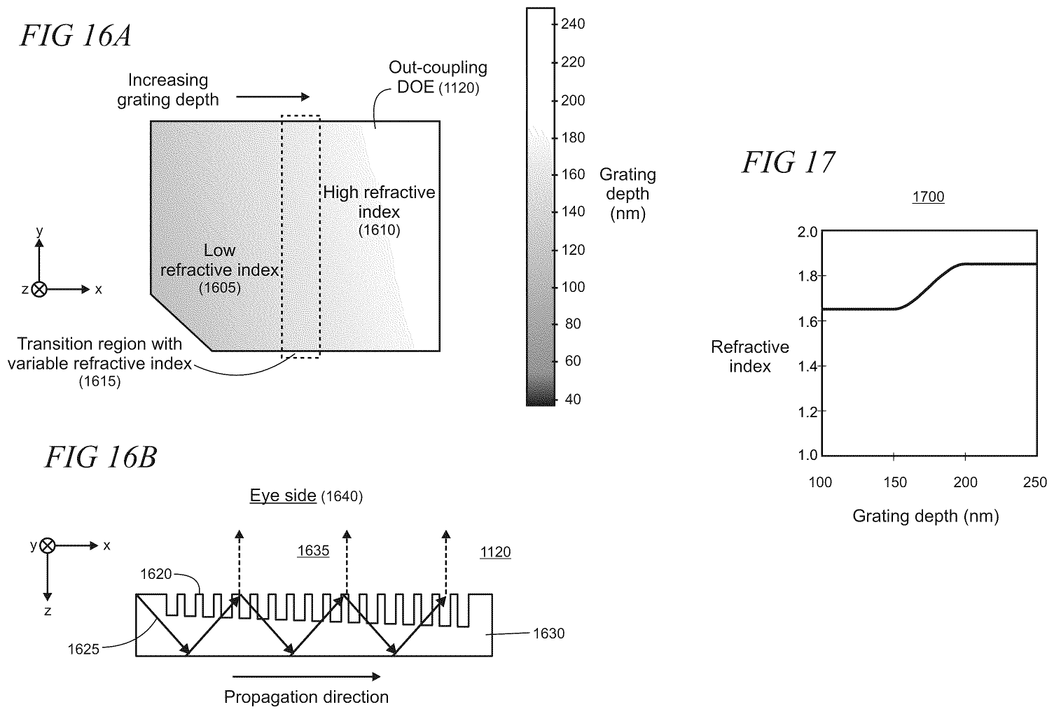

FIG. 16 shows another illustrative embodiment for the SRG in the out-coupling DOE 1120. In this embodiment, a transition region 1615 between the regions of low refractive index 1605 and high refractive index 1610 is defined. FIG. 16B shows an edge view of the out-coupling DOE 1120 with the depth-modulated gratings, as representatively indicated by reference numeral 1620. As shown, virtual image light 1625 enters from the left and propagates in the waveguide 1630 towards the right. As the virtual image light propagates in TIR along the propagation direction, it is out-coupled as beams 1635 towards the eye-side 1640 of the out-coupling DOE. As illustratively shown in the graph 1700 in FIG. 17, the transition region provides a gradually modulated refractive index between 1.65 and 1.8 over a transition window that is bounded by approximately 150 nm to 180 nm grating depth in this particular example. It is emphasized that other suitable grating depth boundaries and refractive index values may be utilized in various implementations of the present principles.

The SRGs with gradient refractive index gratings are fabricated using several different techniques. A first fabrication method utilizes grayscale inkjet printing technologies that are adapted to apply photocurable resins in film layers over a see-through optical substrate that provides an underlying waveguide to an SRG. The photocurable resins have different refractive indexes to provide some design freedom in defining the refractive index gradient over the spatial area of the SRG in an out-coupling DOE. In addition to resins with different refractive indexes, the grayscale inkjet application process enables droplets of resins in the films to have different sizes and be spatially patterned in two-dimensional space. This spatial variation enables additional design freedom in defining a refractive index gradient.

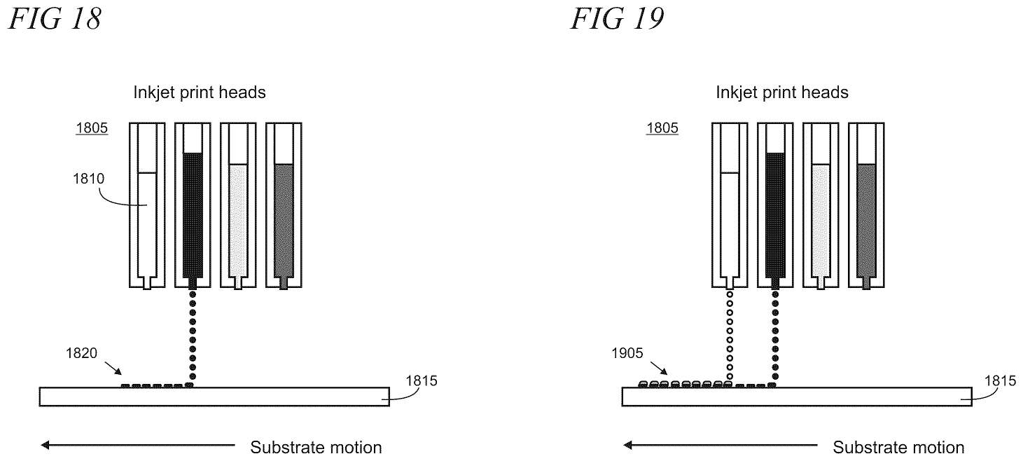

FIG. 18 shows an illustrative array 1805 of inkjet print heads each applying a different resin with a unique refractive index from a resin reservoir (representatively indicated by reference numeral 1810). Four inkjet print heads are shown in the drawing for illustration purposes, but the actual number utilized in a production environment is typically orders of magnitude higher and can vary by implementation and SRG design requirements. Various approaches may be utilized for the generation of inkjet droplets including, for example, continuous inkjet (CIJ) printing and drop on demand (DOD) inkjet printing. In the example shown, an optical substrate 1815 moves relative to the inkjet print head array to enable the resin droplets to be deposited as a film 1820.

Grayscale inkjet printing is further adapted, in some applications of the present principles, as illustratively shown in FIG. 19, to use multiple inkjet print heads simultaneously or in succession to enable resins of the same or different refractive indexes to be stacked in a third dimension (i.e., in a direction normal to the substrate) in a film layer 1905.

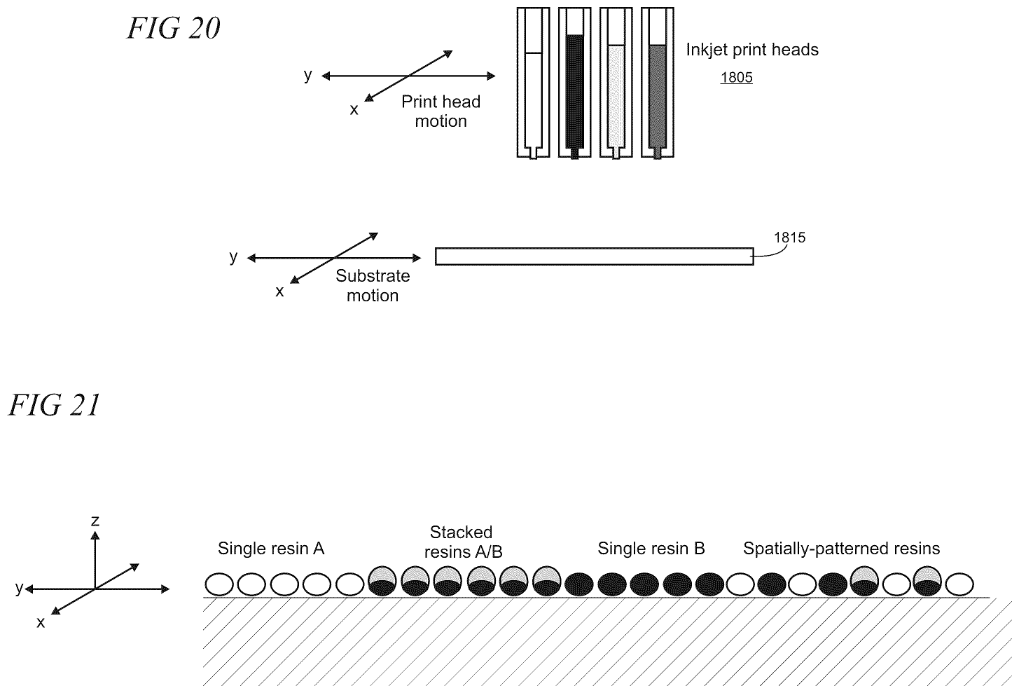

Using the present techniques, resins with the different refractive indexes and droplet size/volumes may be patterned in arrays defined in three-dimensional space in a wet mixing process prior to being cured in a subsequent grating imprinting or replication process such as jet and flash imprint lithography (J-FIL), a form of nanoimprinting lithography (NIL). In some implementations, as shown in FIG. 20, the resin patterning is assisted by relative motion between the print head array 1805 and the substrate along multiple axes, typically in a two-dimensional x-y plane, although relative motion in the z direction may also be utilized in some cases.

FIG. 21 provides an illustrative example of the large scope of design freedom provided by the present grayscale inkjet printing adapted to use variable refractive indexes for different inkjet photocurable resins in a wet mix process. Different resins can be applied in spatial patterns in three-dimensional space, including variations along the plane of the substrate and normal to the substrate by stacking film layers. It may be appreciated that increasing the number of distinct resins and varying the resin droplet size in the grayscale process can further increase the design freedom to implement spatially gradient refractive index gratings for SRGs.

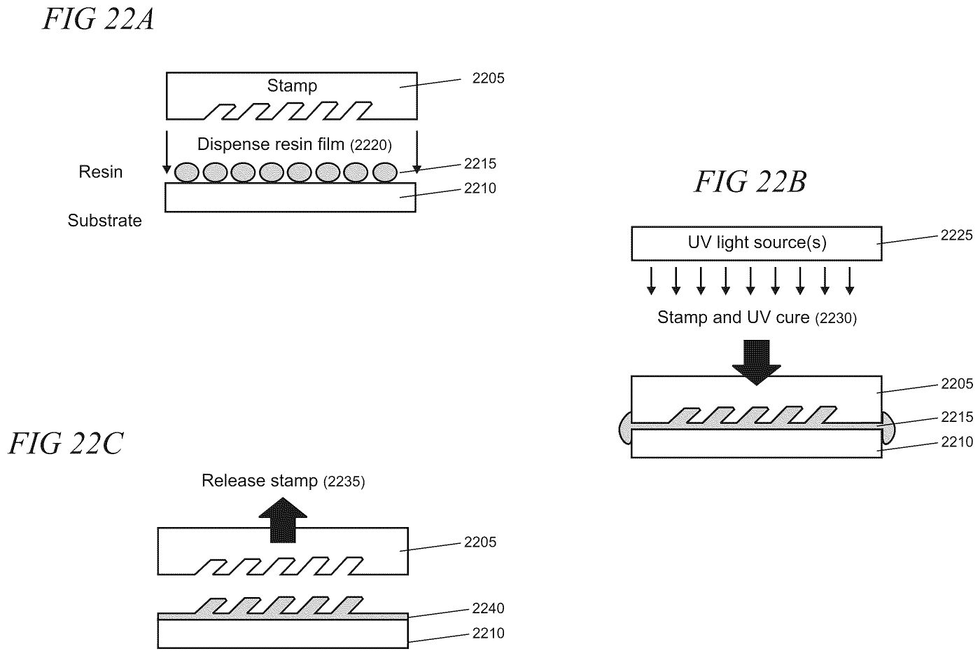

FIGS. 22A, 22B, and 22C show an illustrative process for manufacturing SRGs having depth-modulated gratings using NIL processing such as J-FIL. In FIG. 22A, an elastomer (i.e., “soft”) stamp 2205 is produced from a hard master. The stamp is aligned with an optical substrate 2210 configured as a waveguide on which a deformably-viscous photocurable resin layer 2215 is dispensed using the inkjet printing process discussed above, as indicated by reference numeral 2220.

In FIG. 22B, the stamp 2205 is pressed against the resin layer 2215 using mechanical force to imprint micro-/nanostructures (collectively referred to as nanostructures) in the resin which are then cured using light from one or more UV light sources 2225, as indicated by reference numeral 2230, via cross-linking in the resin. In typical implementations, the mechanical force is relatively low compared to conventional thermal NIL processing and the imprinting can be carried out at room temperature.

In FIG. 22C, the stamp 2205 is released from the cured resin, as indicated by reference numeral 2235. After the stamp is detached, a negative pattern of the stamp is imprinted on the cured resin layer to produce an NIL-imprinted SRG 2240. Some additional curing or other post-processing may be utilized (not shown) in some cases to further develop SRG features or provide additional shaping or treatment. For example, the SRG may be apodized using ashing in a plasma, or atomic layer deposition (ALD) may be utilized to increase resistance of the SRG to variations in environmental factors such as temperature, pressure, humidity, etc.

Subsequent resin development or processing may also be utilized to evacuate resin from the grating trenches to reduce Fresnel reflections that could otherwise be induced at the media interface between the bias layer and the waveguide substrate, which can negatively increase unwanted forward propagation and negatively reduce the FOV of the out-coupling DOE. Plasma ashing, reactive ion beam etching (RIBE), and/or other suitable processes, may aid in removing any residual resin and/or bias layer produced by the inkjet printing down to the substrate in some cases. For example, some of the residual mixture may experience some degree of cross-linking during the resin exposure which may not be amenable to removal through other stripping processes. Accordingly, ashing may be used in addition to, or as an alternative to other stripping processes, depending on the needs of a particular implementation.

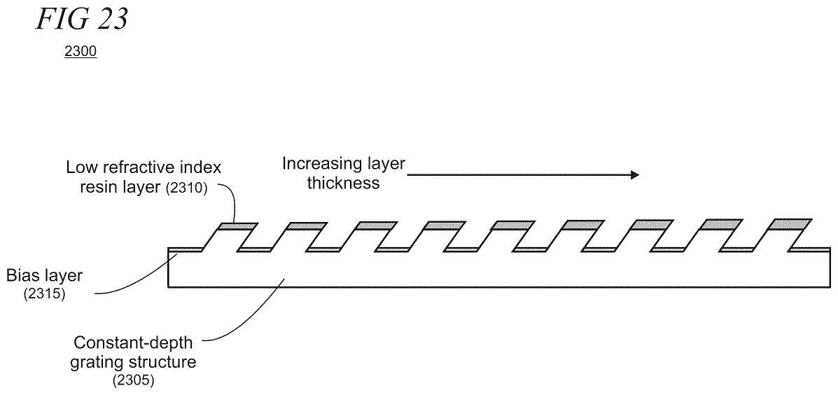

Another fabrication method for SRGs with gradient refractive index gratings utilizes PVD processes. FIG. 23 shows an illustrative SRG 2300 in an out-coupling DOE having a constant-depth grating structure 2305 over which a depth-modulated layer of low refractive index resin 2310 is deposited, for example, using thermal evaporation or sputtering in a vacuum. Use of PVD provides for precise control over the modulated thickness of the resin layer to implement a gradient refractive index for the SRG gratings that meets desired design criteria. In addition, PVD enables a bias layer 2315 to be minimized to reduce unwanted Fresnel reflections from the grating trenches.

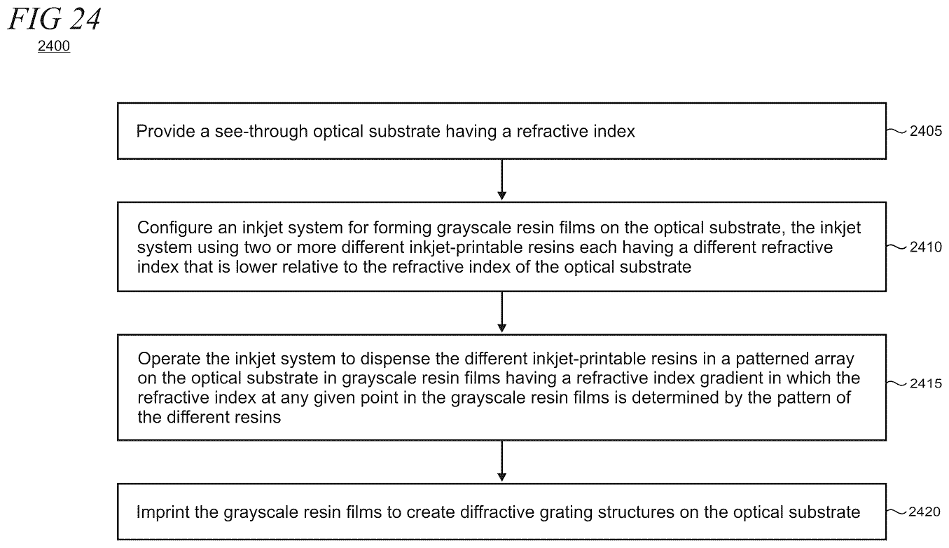

FIG. 24 is a flowchart of an illustrative method 2400 for fabricating an out-coupling DOE usable in the present mixed-reality waveguide combiner with gradient refractive index gratings. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

Block 2405 includes providing a see-through optical substrate having a refractive index. Block 2410 includes configuring an inkjet system for forming grayscale resin films on the optical substrate, the inkjet system using two or more different inkjet-printable resins each having a different refractive index that is lower relative to the refractive index of the optical substrate. Block 2415 includes operating the inkjet system to dispense the different inkjet-printable resins in a patterned array on the optical substrate in grayscale resin films having a refractive index gradient in which the refractive index at any given point in the grayscale resin films is determined by the pattern of the different resins. Block 2420 includes imprinting the grayscale resin films to create diffractive grating structures on the optical substrate.

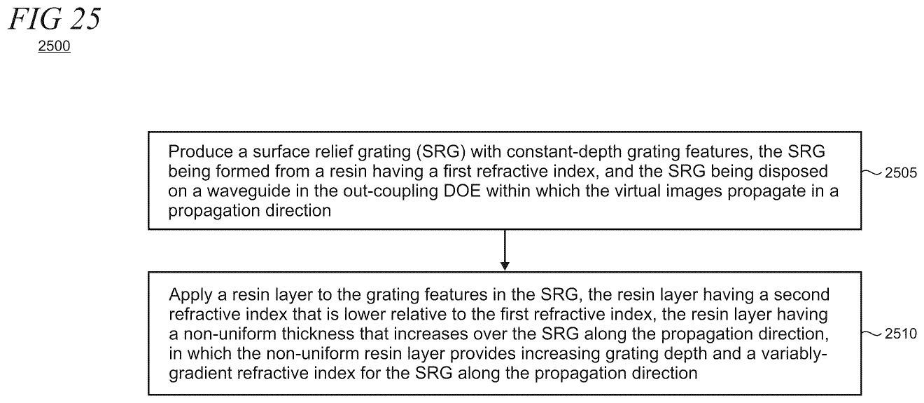

FIG. 25 is a flowchart of an illustrative method 2500 for fabricating an out-coupling DOE usable in the present mixed-reality waveguide combiner with gradient refractive index gratings. Block 2505 includes producing a surface relief grating (SRG) with constant-depth grating features, the SRG being formed from a resin having a first refractive index, and the SRG being disposed on a waveguide in the out-coupling DOE within which the virtual images propagate in a propagation direction. Block 2510 includes applying a resin layer to the grating features in the SRG, the resin layer having a second refractive index that is lower relative to the first refractive index, the resin layer having a non-uniform thickness that increases over the SRG along the propagation direction, in which the non-uniform resin layer provides increasing grating depth and a variably-gradient refractive index for the SRG along the propagation direction.

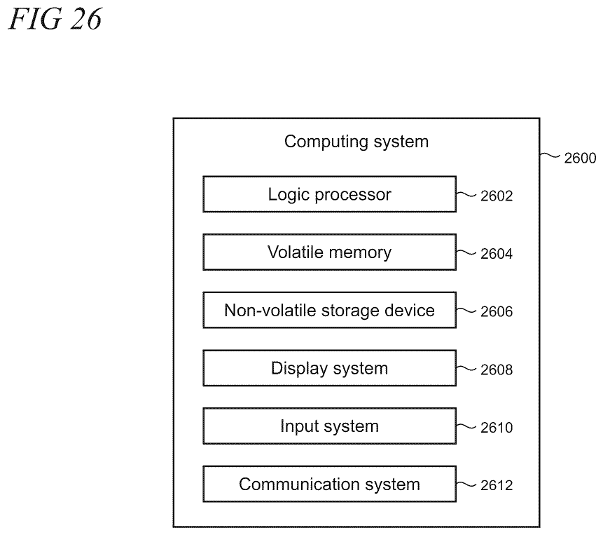

FIG. 26 schematically shows an illustrative example of a computing system 2600 that can enact one or more of the systems, features, functions, methods and/or processes described above for the present mixed-reality waveguide combiner with gradient refractive index gratings. The computing system is shown in simplified form. The computing system may take the form of one or more personal computers, server computers, tablet computers, home-entertainment computers, network computing devices, gaming devices, mobile computing devices, mobile communication devices (e.g., smartphone), wearable computers, and/or other computing devices.

The computing system 2600 includes a logic processor 2602, a volatile memory 2604, and a non-volatile storage device 2606. The computing system may optionally include a display system 2608, input system 2610, communication system 2612, and/or other components not shown in FIG. 26.

The logic processor 2602 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 2602 includes one or more processors configured to execute software instructions. In addition, or alternatively, the logic processor includes one or more hardware or firmware logic processors configured to execute hardware or firmware instructions. Processors of the logic processor may be single-core or multi-core, and the instructions executed thereon are configurable for sequential, parallel, and/or distributed processing. Individual components of the logic processor are optionally distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines.

The non-volatile storage device 2606 includes one or more physical devices configured to hold instructions executable by the logic processors to implement the methods and processes described herein. When such methods and processes are implemented, the state of the non-volatile storage device may be transformed—e.g., to hold different data.

The non-volatile storage device 2606 may include physical devices that are removable and/or built-in. Non-volatile storage device may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. The non-volatile storage device may include non-volatile, dynamic, static, read/write, read-only, sequential-access, location-addressable, file-addressable, and/or content-addressable devices. It will be appreciated that the non-volatile storage device is configured to hold instructions even when power is cut to the non-volatile storage device.

The volatile memory 2604 may include physical devices that include random access memory. The volatile memory is typically utilized by the logic processor 2602 to temporarily store information during processing of software instructions. It will be appreciated that the volatile memory typically does not continue to store instructions when power is cut to the volatile memory.

Aspects of logic processor 2602, volatile memory 2604, and non-volatile storage device 2606 are capable of integration into one or more hardware-logic components. Such hardware-logic components include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” is typically used to describe an aspect of computing system 2600 implemented in software by a processor to perform a particular function using portions of volatile memory, which function involves transformative processing that specially configures the processor to perform the function. Thus, a program may be instantiated via the logic processor 2602 executing instructions held by the non-volatile storage device 2606, using portions of the volatile memory 2604. It will be understood that different programs may be instantiated from the same application, service, code block, object, library, routine, API (application programming interface), function, etc. Likewise, the same program may be instantiated by different applications, services, code blocks, objects, routines, APIs, functions, etc. A program may encompass individual or groups of executable files, data files, libraries, drivers, scripts, database records, etc.

When included, the display system 2608 may be used to present a visual representation of data held by the non-volatile storage device 2606. This visual representation may take the form of a graphical user interface (GUI). As the herein described methods and processes change the data held by the non-volatile storage device, and thus transform the state of the non-volatile storage device, the state of the display system 2608 is likewise transformed to visually represent changes in the underlying data. The display system may include one or more display devices utilizing virtually any type of technology; however, one utilizing a MEMS projector to direct laser light may be compatible with the eye-tracking system in a compact manner. Such display devices may be combined with the logic processor 2602, volatile memory 2604, and/or non-volatile storage device 2606 in a shared enclosure, or such display devices may be peripheral display devices.

When included, the input system 2610 may comprise or interface with one or more user-input devices such as a keyboard, mouse, touch screen, or game controller. In some embodiments, the input system may comprise or interface with selected natural user input (NUI) componentry. Such componentry may be integrated or peripheral, and the transduction and/or processing of input actions may be handled on- or off-board. Example NUI componentry includes a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, the communication system 2612 may be configured to communicatively couple various computing devices described herein with each other, and with other devices. The communication system may include wired and/or wireless communication devices compatible with one or more different communication protocols. As non-limiting examples, the communication system may be configured for communication via a wireless telephone network, or a wired or wireless local- or wide-area network. In some embodiments, the communication system may allow computing system 2600 to send and/or receive messages to and/or from other devices via a network such as the Internet.

Various exemplary embodiments of the present mixed-reality waveguide combiner with gradient refractive index gratings are now presented by way of illustration and not as an exhaustive list of all embodiments. An example includes an out-coupling diffractive optical element (DOE) in a waveguide combiner in a mixed-reality display system, employable by a user, that combines virtual images and views of a real world, comprising: a see-through optical substrate having a first refractive index, the optical substrate propagating virtual images in total internal reflection along a propagation direction; and a surface relief grating (SRG) disposed on the optical substrate, the SRG including slanted gratings having a depth that increases along the propagation direction of the virtual images, the SRG configured for out-coupling the virtual images to an eye of the user, wherein the SRG comprises gratings in at least two distinct regions, a first region including gratings with a first refractive index that is lower relative to the refractive index of the optical substrate, and a second region including gratings with a second refractive index that is higher relative to the refractive index of gratings in the first region, and wherein the regions are based on the grating depth in which grating depth is shallower for gratings in the first region relative to gratings in the second region.

In another example, the SRG in the out-coupling DOE is further configured to expand an exit pupil of the virtual images. In another example, the out-coupling DOE further comprises a third region that is spatially disposed between the first region and the second region, in which the third region comprises gratings with a third refractive index that is between the first and second refractive indexes. In another example, the refractive index of gratings in the third region is variable based on spatial location of gratings within the third region. In another example, the first refractive index of the gratings in the first region is continuously variable between a lowest value for gratings in the first region having farthest spatial separation from the second region and a highest value for gratings in the first region having closest spatial separation from the second region. In another example, the second refractive index of the gratings in the second region is continuously variable between a lowest value for gratings in the second region having closest spatial separation from the first region and a highest value for gratings in the second region having farthest spatial separation from the first region. In another example, gratings in the SRG are slanted. In another example, the gratings in the third region comprise two or more inkjet resin films having different refractive indexes. In another example, the two or more inkjet resin films are layered. In another example, the two or more inkjet resin films are configured in a one-dimensional or two-dimensional patterned array. In another example, the two or more inkjet resin films are at least partially merged.

A further example includes a method for fabricating an out-coupling diffractive optical element (DOE), in a mixed-reality display system, that out-couples virtual images over views, by a user, of a real world, the method comprising: providing a see-through optical substrate having a refractive index; configuring an inkjet system for forming grayscale resin films on the optical substrate, the inkjet system using two or more different inkjet-printable resins each having a different refractive index that is lower relative to the refractive index of the optical substrate; operating the inkjet system to dispense the different inkjet-printable resins in a patterned array on the optical substrate in grayscale resin films having a refractive index gradient in which the refractive index at any given point in the grayscale resin films is determined by the pattern of the different resins; and imprinting the grayscale resin films to create diffractive grating structures on the optical substrate.

In another example, the patterned array is defined by one or more of resin type or droplet size. In another example, the array comprises a one-dimensional array or a two-dimensional array in a plane of the optical substrate. In another example, the inkjet-printable resins are ultraviolet (UV) light-curable and the imprinting comprises nanoimprint lithography. In another example, the nanoimprint lithography comprises jet and flash imprint lithography. In another example, the inkjet system operating comprises dispensing the different inkjet-printable resins using a wet mixing process.

A further example includes a method for fabricating an out-coupling diffractive optical element (DOE), in a mixed-reality display system, that out-couples virtual images over views, by a user, of a real world, the method comprising: producing a surface relief grating (SRG) with constant-depth grating features, the SRG being formed from a resin having a first refractive index, and the SRG being disposed on a waveguide in the out-coupling DOE within which the virtual images propagate in a propagation direction; and applying a resin layer to the grating features in the SRG, the resin layer having a second refractive index that is lower relative to the first refractive index, the resin layer having a non-uniform thickness that increases over the SRG along the propagation direction, in which the non-uniform resin layer provides increasing grating depth and a variably-gradient refractive index for the SRG along the propagation direction.

In another example, the resin layer is applied using one of thin-film evaporative deposition, physical vapor deposition, chemical vapor deposition, inkjet coating, or spin coating. In another example, the method further includes assembling the SRG to the waveguide to create the out-coupling DOE, in which the waveguide is further utilized for an in-coupling DOE and an intermediate DOE, the in-coupling DOE configured for in-coupling the virtual images into the waveguide, the intermediate DOE configured for expanding an exit pupil for the virtual images in a first direction while propagating the virtual images to the out-coupling DOE, and wherein the out-coupling DOE expands the exit pupil for the virtual images in a second direction that is orthogonal to the first direction.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. An out-coupling diffractive optical element (DOE) in a waveguide combiner in a mixed-reality display system, employable by a user, that combines virtual images and views of a real world, comprising:
a see-through optical substrate having a first refractive index, the optical substrate propagating virtual images in total internal reflection along a propagation direction; and
a surface relief grating (SRG) disposed on the optical substrate, the SRG including slanted gratings having a depth that increases along the propagation direction of the virtual images, the SRG configured for out-coupling the virtual images to an eye of the user,
wherein the SRG comprises gratings in at least two distinct regions, a first region including gratings with a first refractive index that is lower relative to the refractive index of the optical substrate, and a second region including gratings with a second refractive index that is higher relative to the refractive index of gratings in the first region, and
wherein the regions are based on the grating depth in which grating depth is shallower for gratings in the first region relative to gratings in the second region.

2. The out-coupling DOE of claim 1 in which the SRG in the out-coupling DOE is further configured to expand an exit pupil of the virtual images.

3. The out-coupling DOE of claim 1 further comprising a third region that is spatially disposed between the first region and the second region, in which the third region comprises gratings with a third refractive index that is between the first and second refractive indexes.

4. The out-coupling DOE of claim 3 in which the refractive index of gratings in the third region is variable based on spatial location of gratings within the third region.

5. The out-coupling DOE of claim 1 in which the first refractive index of the gratings in the first region is continuously variable between a lowest value for gratings in the first region having farthest spatial separation from the second region and a highest value for gratings in the first region having closest spatial separation from the second region.

6. The out-coupling DOE of claim 1 in which the second refractive index of the gratings in the second region is continuously variable between a lowest value for gratings in the second region having closest spatial separation from the first region and a highest value for gratings in the second region having farthest spatial separation from the first region.

7. The out-coupling DOE of claim 1 in which gratings in the SRG are slanted.

8. The out-coupling DOE of claim 1 in which the gratings in the third region comprise two or more inkjet resin films having different refractive indexes.

9. The out-coupling DOE of claim 8 in which the two or more inkjet resin films are layered.

10. The out-coupling DOE of claim 8 in which the two or more inkjet resin films are configured in a one-dimensional or two-dimensional patterned array.

11. The out-coupling DOE of claim of claim 8 in which the two or more inkjet resin films are at least partially merged.

12. A method for fabricating an out-coupling diffractive optical element (DOE), in a mixed-reality display system, that out-couples virtual images over views, by a user, of a real world, the method comprising:
providing a see-through optical substrate having a refractive index;
configuring an inkjet system for forming grayscale resin films on the optical substrate, the inkjet system using two or more different inkjet-printable resins each having a different refractive index that is lower relative to the refractive index of the optical substrate;
operating the inkjet system to dispense the different inkjet-printable resins in a patterned array on the optical substrate in grayscale resin films having a refractive index gradient in which the refractive index at any given point in the grayscale resin films is determined by the pattern of the different resins; and
imprinting the grayscale resin films to create diffractive grating structures on the optical substrate.

13. The method of claim 12 in which the patterned array is defined by one or more of resin type or droplet size.

14. The method of claim 12 in which the array comprises a one-dimensional array or a two-dimensional array in a plane of the optical substrate.

15. The method of claim 12 in which the inkjet-printable resins are ultraviolet (UV) light-curable and the imprinting comprises nanoimprint lithography.

16. The method of claim 15 in which the nanoimprint lithography comprises jet and flash imprint lithography.

17. The method of claim 12 in which the inkjet system operating comprises dispensing the different inkjet-printable resins using a wet mixing process.

18. A method for fabricating an out-coupling diffractive optical element (DOE), in a mixed-reality display system, that out-couples virtual images over views, by a user, of a real world, the method comprising:
producing a surface relief grating (SRG) with constant-depth grating features, the SRG being formed from a resin having a first refractive index, and the SRG being disposed on a waveguide in the out-coupling DOE within which the virtual images propagate in a propagation direction; and
applying a resin layer to the grating features in the SRG, the resin layer having a second refractive index that is lower relative to the first refractive index, the resin layer having a non-uniform thickness that increases over the SRG along the propagation direction, in which the non-uniform resin layer provides increasing grating depth and a variably-gradient refractive index for the SRG along the propagation direction.

19. The method of claim 18 in which the resin layer is applied using one of thin-film evaporative deposition, physical vapor deposition, chemical vapor deposition, inkjet coating, or spin coating.

20. The method of claim 18 further including assembling the SRG to the waveguide to create the out-coupling DOE, in which the waveguide is further utilized for an in-coupling DOE and an intermediate DOE, the in-coupling DOE configured for in-coupling the virtual images into the waveguide, the intermediate DOE configured for expanding an exit pupil for the virtual images in a first direction while propagating the virtual images to the out-coupling DOE, and wherein the out-coupling DOE expands the exit pupil for the virtual images in a second direction that is orthogonal to the first direction.
